(19) United States
(12) Patent Application Publication
(10) Pub. No.: US 2010/0272182 A1
(43) Pub. Date: Oct. 28, 2010

(54) Image flow knowledge assisted latency-free in-loop temporal filter

(75) Inventor: Hitoshi Watanabe, San Jose, CA (US)

Correspondence Address: RABIN & Berdo, PC, 1101 14TH STREET, NW, SUITE 500, WASHINGTON, DC, 20005, US

(73) Assignee: QUANTA INTERNATIONAL LIMITED, Grand Cayman (KY)

(21) Appl. No.: 12/801,827

(22) Filed: Jun. 28, 2010

Related U.S. Application Data
(63) Continuation-in-part of application No. 11/166,705, filed on Jun. 23, 2005.
(60) Provisional application No. 60/582,426, filed on Jun. 23, 2004.

(51) Int. Cl. H04N 7/26

(52) U.S. Cl. 375/240.16; 375/E07.123

(57) ABSTRACT

Digital image acquisition device such as CCD/CMOS sensors often introduces random temporal noise into digital video sequences. Temporal noise generally carries high frequency components in both the spatial and temporal domains and is also random in nature. Because of these properties, they are generally very expensive to encode and would substantially degrade coding efficiency. It is therefore important to eliminate or suppress such temporal noise in video inputs prior to encoding. The present invention provides a methodology to achieve such a goal in a highly cost-effective manner where coding performance, latency, computational cost, and memory requirements are optimized. This methodology can be efficiently implemented as part of digital video compression algorithm and scales nicely for various bitrates.

### CROSS REFERENCE

This application is a Continuation-In-Part of application Ser. No. 11/166,705, filed on Jun. 23, 2005, which claims priority from a United States provisional patent application entitled “Image Flow Knowledge Assisted Latency-Free In-loop Temporal Filter” filed on Jun. 23, 2004, having an application No. 60/582,426. This provisional patent application is incorporated herein by reference.

### FIELD OF INVENTION

This invention relates to digital video compression algorithms as well as digital signal filtering algorithms, in which digital signal filtering is applied to input images.

### BACKGROUND

Digital video sequences often suffer from random temporal noise, which is typically introduced during the capturing process by video acquisition device such as CCD/CMOS sensors. Temporal noise generally carries high frequency components in both the spatial and temporal domains and is also random in both spatial and temporal domains. Because of these issues, they are generally very expensive to encode and would substantially degrade coding efficiency. Even when they are encoded, they generally degrade the perceptual quality of the reconstructed video. It is therefore important to eliminate or at least suppress such temporal noise in video inputs prior to encoding.

One of the most popular methodologies to suppress temporal noise is to apply temporal smoothing to raw images using motion compensation, either in the form of preprocessing or during the encoding process. In the first case, motion vectors calculated based on raw-to-raw image motion matching during preprocessing is generally used, either directly or indirectly, for actual motion estimation. However, this approach inevitably incurs latency overhead between input and encoding as well as memory overhead to store pre-determined motion vectors. Both of these additional costs are generally undesirable for many consumer electronics applications.

In the second case, W. Ding, in U.S. Pat. No. 6,005,626, proposed a scheme in which motion vectors are calculated based on raw-to-raw image motion matching which are then used to perform temporal smoothing of raw images. These motion vectors are then used for actual motion matching purposes as well. Therefore, this scheme can be considered as temporal smoothing during encoding instead of as preprocessing. FIG. 1 illustrates such prior art method based on raw-to-raw motion matching in applying temporal average to raw images. Block 1 on a current raw frame 102 is mapped to block 0 on the previous raw frame 100. The mapping was derived by applying motion matching between raw frame 102 and raw frame 100. Block 1 and block 0 are then averaged and block 1 is updated by the result (of the average) to generate block 2 of frame 104.

Although this approach is an improved one when compared with the first case in terms of latency and frame buffer overhead, however, it tends to suffer from deviation between motion vectors derived from raw-to-raw image motion matching and those based on recon-to-raw images due to recon quality degradation, especially at aggressive bit rates. At such bit rates, recon images can deviate from corresponding raw images and therefore motion vectors calculated from raw-to-raw motion matching are not necessarily better than those derived based on recon-to-raw images in terms of coding efficiency and performance. In such case, the usage of motion vectors calculated based on raw-to-raw motion matching for actual motion compensation generally produces poor recon movies.

### SUMMARY OF INVENTION

An object of the present invention is to provide methods for encoding images that minimize temporal noise.

Another object of the present invention is to provide methods for temporal smoothing that are efficient and scalable.

Briefly, this invention discloses methods for video encoding, comprising the steps of finding a recon block on a previous recon frame which matches to a current raw block on a current raw frame; calculating a motion vector between a said recon block on a said previous recon frame and a said current raw block on a said current raw frame; determining a corresponding raw block on a previous raw frame to said recon block on said previous recon frame; mixing said current raw block and said corresponding raw block to generate a new raw block; and using said motion vector for encoding said new raw block. Note that a new raw block can be generated as described above or that the current raw block can be updated or replaced—all of these methods are acceptable. In the processing of the next frame, either the original raw block or the new raw block can be used.

An advantage of the present invention is that it provides methods for encoding images that minimize temporal noise.

Another advantage of the present invention is that it provides methods for temporal smoothing that are efficient and scalable.

### DESCRIPTION OF THE FIGURES

FIG. 1 is a block diagram illustrating a prior art method based on raw-to-raw motion matching in applying temporal average to raw images.

FIG. 2 is a block diagram illustrating a presently preferred method of the present invention in applying temporal average to raw images.

FIG. 3 is a block diagram showing the specific steps of a preferred method of the present invention in applying temporal averaging to the pixels of an input raw image.

FIG. 4 is a block diagram illustrating a video encoding method based on a preferred method of the present invention in applying temporal smoothing shown in FIG. 2.

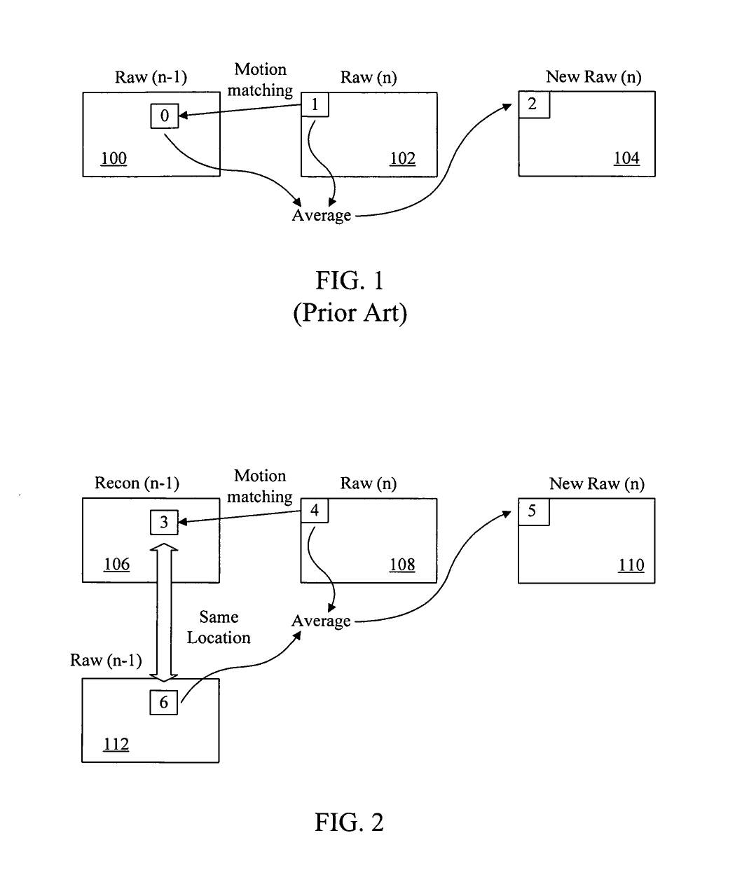

### DETAILED DESCRIPTION OF THE PREFERRED EMBODIMENTS

The presently preferred methods of the present invention provide methods that use motion vectors calculated from recon-to-raw motion matching for temporal smoothing. For the purpose of this application, “raw” is commonly referred to as images received from “input” to the engine, which performs temporal smoothing as well as encoding/trans-coding operation, and “recon” is commonly referred to as images received from “output” and has already undergone encoding/trans-coding process by the engine and has been reconstructed to be used as reference pictures for the purpose of inter-picture prediction as part of encoding/trans-coding process. This approach not only enables an implementation where improved latency and reduced frame buffer size are realized, but also leads to a scalable performance which is built into its underlying algorithm structure.

At very high bit rates, since recon images are closer to raw images, the preferred methods tend to behave like approaches based on raw-to-raw motion matching. Coding performance is generally very close between these two approaches.

At lower bit rates, the preferred methods are yet sufficient enough so that the main features on the raw image are still reasonably well reconstructed (hereafter “Ambient Bit Rates”), and the differences between recon and raw images become larger. At Ambient Bit Rates, most of the real features present on the raw frame whose signals are strong enough to be visible are still well reconstructed.

Since high frequency components are generally first to be thrown away, the difference between raw and recon images mainly manifest themselves in high frequency components. Here, temporal noise generally has high spatial frequency components, where such noise generally tends to become weaker on recon images at Ambient Bit Rates. Because of this, recon-to-raw motion matching is less susceptible to temporal noise at Ambient Bit Rates, and resulting motion vectors are more reliable than those based on raw-to-raw motion matching. As a consequence, temporal smoothing based on our scheme performs superior to that based on raw-to-raw motion matching.

At even lower bit rates where recon and raw images start to significantly deviate, optimal motion vectors calculated based on recon-to-raw motion matching also start to deviate from those based on raw-to-raw motion matching. First of all, for the purpose of achieving better coding efficiency, it is better to use motion vectors based on recon-to-raw motion matching. Therefore, in the scheme using raw-to-raw motion matching, motion vectors must be re-calculated for the purpose of encoding and this will be a significant computational overhead. Second, for temporal smoothing, if we map raw images using motion vectors calculated based on recon-to-raw motion vectors, we may map visually different image portions. However, color accuracy requirement is introduced (see below) to avoid overly aggressive smoothing between erroneously mapped raw image portions. Also, at this aggressive bit rates, temporal noise is generally not encoded well and their influence is relatively small.

The notion of deviation between raw images received from input and recon images received from output is also applicable to trans-coding operation in a similar context, where raw images received from input corresponds to decoded and reconstructed image based on pre-encoded input signal, and recon images received from output corresponds to trans-coded/re-encoded image corresponding to the output signal. In case of trans-coding, raw images received from input may contain coding artifacts depending on the encoding condition utilized previously, which will also contribute as temporal noise for the purpose of re-encoding. However, a temporal filter based on recon-to-raw motion matching will also smooth out such temporal noise contributed by raw images received from input during trans-coding operation in a scalable fashion mentioned above.

Temporal smoothing is applied by applying averaging of some sort to the currently reconstructed portion of raw image and its temporally corresponding portion of previous raw image. To decide if and how aggressively to average, we construct a measure indicating aggressiveness of averaging (hereinafter “Aggressiveness Measure”) which depends on both accuracy of motion vector (“Motion Accuracy”) as well as color deviation between previous and current raw image (“Color Deviation”).

Motion Accuracy serves as a confidence factor as to how good the calculated motion vector corresponds to the actual image flow present on raw images. Color Deviation serves as confidence factor as to how good the motion matched portions of two raw images map to each other. Those two measures are useful to avoid unreasonably aggressive averaging, especially when recon and raw start to deviate substantially at aggressive bit rates for a given video input. The Aggressiveness Measure may be designed as a function of Motion Accuracy and Color Deviation, including but not limited to a monotonic function of Motion Accuracy and Color Deviation, where this function increases as Motion Accuracy or Color Deviation increases. The Aggressiveness Measure is then used to decide how much we mix the previous raw image into the current raw image. To decide whether to apply averaging may be done on each pixel basis, on a sub-region basis inside a block or on the entire block basis. The results of experiments show that the presently preferred methods consistently outperform those based on raw-to-raw motion matching in terms of overall coding performance (including coding efficiency and visual quality).

In one preferred embodiment, we may apply averaging based on the Aggressiveness Measure. In another preferred embodiment, we pre-calculate threshold values for Motion Accuracy and Color Deviation, and apply averaging based on the Aggressiveness Measure if both Motion Accuracy and Color Deviation meet its corresponding threshold limit.

In one specific embodiment of the method proposed in FIG. 2 where an image is processed on block basis and in a raster scan order, Motion Accuracy is defined as the maximum of absolute x- and y-component motion vector differences among current and previously reconstructed blocks (hereinafter “Reference Blocks”). For example, FIG. 2 illustrates a presently preferred method of the present invention in applying temporal average to raw images. Block 4 on a current raw frame 108 is first mapped to block 3 on the previous recon frame 106. The mapping was derived by applying motion matching between raw frame 108 and recon frame 106. The raw frame 108 is received from input to an engine, which performs temporal smoothing as well as encoding/trans-coding operation, and the recon frame 106 is received from output of the engine and has already undergone encoding or trans-coding process and has been reconstructed. Then, block 6 on the raw frame 112 which has the same location as block 3 on the recon frame 106 is identified. The raw frame 112 is received from the input to the engine. Block 4 and block 6 are then averaged and block 4 is updated by the result to generate block 5.

For the purpose of this invention, the order in which blocks are processed can be arbitrary. However, to take advantage of the fact that closer blocks generally have stronger correlation than distant blocks, it is beneficial to adopt a continuous scan order instead of a discontinuous one and to choose closer neighboring blocks as Reference Blocks. Furthermore, in order to avoid latency, it is convenient to use previously reconstructed blocks. The neighbors may be just one block or a set of blocks. In this preferred method, top and left blocks are chosen, and set the threshold for Motion Accuracy is set to N_thresh (pixel). We also define Color Deviation at each pixel as a pair-wise absolute color difference in the luminance component (Y) in YUV representation between the mapped blocks. In this embodiment, we set the threshold for Color Deviation to ΔY_thresh (in the same unit as Y). In one specific application, we set N_thresh=1 (pixel) and ΔY_thresh=10.

The first frame must be encoded without reference to a previously reconstructed frame (“I-frame”). A group of frames up to the next I-frame is called Group of Pictures (“GOP”).

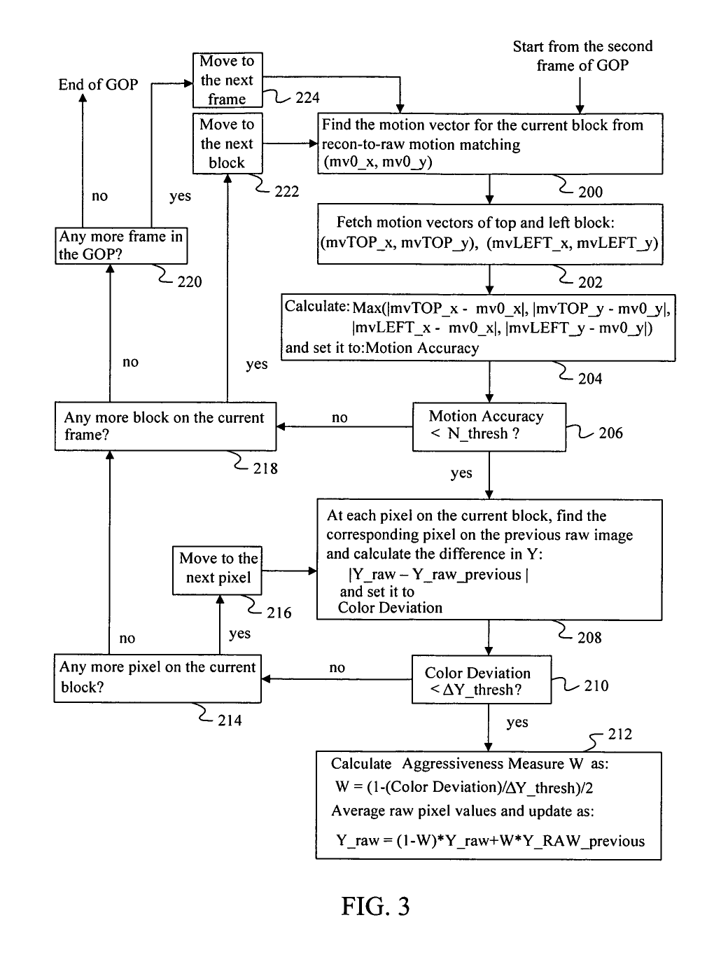

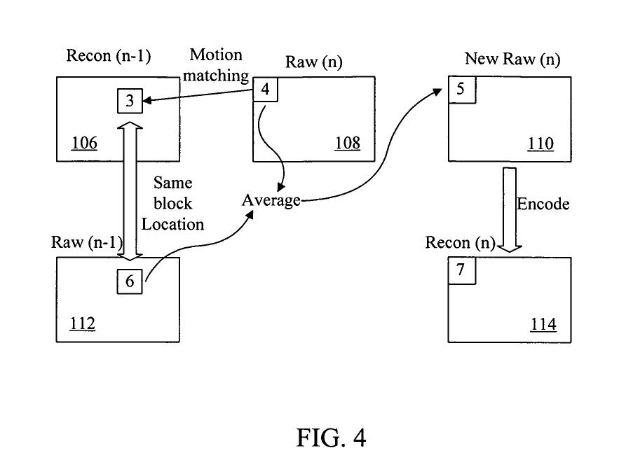

From the second frame of the current GOP, motion matching is performed on a block basis in a raster scan order between the current raw frame (108 in FIG. 2) and the previously reconstructed frame (106 in FIG. 2). We then proceed with temporal averaging in accordance with the following steps as shown in FIG. 3.

1. For each block, step 200, find the motion vector for the current block (mv0_x, mv0_y);

2. Next, step 202, fetch the motion vectors of top block (mvTOP_x, mvTOP_y) and left block (mvLEFT_x, mvLEFT_y) previously calculated and stored;

3. Next, step 204, calculate absolute x- and y-component motion vector differences between current and top and left blocks, |mvTOP_x−mv0_x|, |mvTOP_y−mv0_y|, |mvLEFT_x−mv0_x|, |mvLEFT_y−mv0_y|; then, set the maximum of these four quantities as Motion Accuracy:

Motion Accuracy=Max(|mvTOP_{—}x−mv0_{—}x|, |mvTOP_{—}y−mv0_{—}y|, |mvLEFT_{—}x−mv0_{—}x|, |mvLEFT_{—}y−mv0_{—}y|);

4. Next, step 206, check to see if Motion Accuracy is less than N_thresh; If no, move to the next block on the current raw frame if any, or move to the next frame if no more blocks on the current raw frame. If yes, proceed to the next step below.

5. Step 208, scan all the pixels on the current block. At each pixel, find the luminance value, Y_raw, as well as that for the corresponding pixel on the mapped block on the previous raw frame, Y_raw_previous. We then calculate their absolute color difference in luminance component (Y), |Y_raw−Y_raw_previous|and set it to Color Deviation:

Color Deviation=|Y_raw−Y_raw_previous|;

6. Next, step 210, we check to see if Color Deviation is less than ΔY_thresh. If no, move to the next pixel on the current raw block if any, step 216, or move to the next block if no more pixels on the current raw block are available, step 218. If yes, proceed to the next step below.

7. Calculate Aggressiveness Measure W:

W=(1−Color Deviation/ΔY_thresh)/2;

or

W=(1−Color Deviation/ΔY_thresh)*(1−Motion Accuracy/N_thresh)/2;

or

W=(1−(Color Deviation/ΔY_thresh)̂{n})*(1−(Motion Accuracy/N_thresh)̂{n})/2; (n=1, 2, 3, . . . )

or

any other monotonically decreasing function of Color Deviation and/or Motion Accuracy; and apply averaging and update the current raw pixel luminance value according to the following formula:

Y_raw=(1−W)*Y_raw+W*Y_raw_previous;

8. Move to the next pixel on the current raw block if any, or move to the next block if no more pixels on the current raw block is available.

9. Repeat the above procedure until processing is complete.

Notice that this approach assumes no latency, additional buffer to store pre-determined motion vectors or significant computational overhead, yet it produces the expected results for all bit rates without suffering unnecessary quality degradation. Also, due to a recursive nature of modifying “Y_raw” above [35], there is no necessity to store original “Y_raw”, and original “Y_raw” can be replaced and overwritten by the modified “Y_raw”. This helps to reduce a size of buffer to store frame data.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A method for video encoding, comprising the steps of:
calculating a motion vector between a recon block on a previous recon frame and a current raw block on a current raw frame, wherein the previous recon frame is received from output of an engine and has already undergone encoding or trans-coding process by the engine and has been reconstructed, the current raw block is received from input to the engine;
determining a corresponding raw block on a previous raw frame to said recon block on said previous recon frame, wherein the previous raw frame is received from the input to the engine;
mixing said current raw block and said corresponding raw block to generate a new raw block; and
using said motion vector for encoding said new raw block.

2. The method for video encoding of claim 1, wherein motion accuracy is determined as a function of the neighboring blocks of said current raw block.

3. The method of video encoding of claim 2, wherein said mixing step is performed as a function of said motion accuracy.

4. The method for video encoding of claim 1, wherein color deviation is determined as a function of said current raw block and said corresponding raw block.

5. The method of video encoding of claim 4, wherein said mixing step is performed as a function of said color deviation.

6. The method for video encoding of claim 2, wherein color deviation is determined as a function of said current raw block and said corresponding raw block.

7. The method of video encoding of claim 6, wherein said mixing step is performed as a function of said motion accuracy and said color deviation.

8. A method for image processing, comprising the steps of:
calculating a motion vector between a recon block of a previous recon frame and a current raw block of a current raw frame, wherein the previous recon frame is received from output of an engine and has already undergone encoding or trans-coding process by the engine and has been reconstructed, the current raw block is received from input to the engine;
determining motion accuracy as a function of one or more neighboring motion vectors relative to said current raw block of said current raw frame;
evaluating color deviation between said current raw block and a corresponding previous raw block of a previous raw frame, wherein the previous raw frame is received from the input to the engine;
calculating an aggressiveness measure; and
determining a new raw block for said current frame as a function of said aggressiveness measure, said current raw block, and said previous raw block.

9. The method for image processing of claim 8, wherein in said determining motion accuracy step, if said motion accuracy is greater than a first predefined threshold value, processing is complete for said current raw block.

10. The method for image processing of claim 8, wherein said one or more neighboring motion vectors are the top block and the left block relative to said current raw block of said current raw frame.

11. The method for image processing of claim 8, wherein in said determining color deviation step, if said color deviation is greater than a second predefined threshold value, processing is complete for said current raw block.

12. The method for image processing of claim 8, wherein said aggressiveness measure is calculated as a function of said motion accuracy.

13. The method for image processing of claim 8, wherein said aggressiveness measure is calculated as a function of said color deviation.

14. The method for image processing of claim 8, wherein said aggressiveness measure is calculated as a function of said motion accuracy and color deviation.

15. A method for image processing, comprising the steps of:
calculating a motion vector between a recon block of a previous recon frame and a current raw block of a current raw frame, wherein the previous recon frame is received from output of an engine and has already undergone encoding or trans-coding process by the engine and has been reconstructed, the current raw block is received from input to the engine;
determining motion accuracy as a function of one or more neighboring motion vectors relative to said current raw block of said current raw frame;
if said motion accuracy is less than a first predefined threshold, evaluating color deviation between said current raw block and a corresponding previous raw block of a previous raw frame, wherein the previous raw frame is received from the input to the engine;
if said color deviation is less than a second predefined threshold, calculating an aggressiveness measure; and
determining a new raw block for said current frame as a function of said aggressiveness measure, said current raw block, and said previous raw block.

16. The method for image processing of claim 15, wherein said one or more neighboring motion vectors are the top block and the left block relative to said current raw block of said current raw frame.

17. The method for image processing of claim 15, wherein said aggressiveness measure is calculated as a function of said motion accuracy.

18. The method for image processing of claim 15, wherein said aggressiveness measure is calculated as a function of said color deviation.

19. The method for image processing of claim 15, wherein said aggressiveness measure is calculated as a function of said motion accuracy and color deviation.
